(19) United States
(12) Patent Application Publication
(10) Pub. No.: US 2011/0077789 A1
(43) Pub. Date: Mar. 31, 2011

(54) SYSTEM AND METHOD FOR POWER MANAGEMENT

(76) Inventor: Chun-I SUN, Taipei County (TW)

(21) Appl. No.: 12/856,997

(22) Filed: Aug. 16, 2010

(30) Foreign Application Priority Data
Sep. 29, 2009 (TW) 098132832

(51) Int. Cl. G06F 1/26

(52) U.S. Cl. 700/291

(57) ABSTRACT

The present invention relates to a system and a method of power management. The system at least includes a power consumption detector and a controller. The power consumption detector is disposed between a socket and an electric appliance for detecting power consumption of the electric appliance. The controller is used for acquiring the power consumption detected by the power consumption detector, and estimating a total allowance according to long-term total power consumption. When the user input target allowance through the controller, and the target allowance is different from the total allowance, the controller schemes out an operation rule and an operation time of the electric appliance according to the characteristic of the electric appliance, the total allowance and the target allowance.

This application claims priority of No. 098132832 filed in Taiwan R.O.C. on 2009/9/29 under 35 USC 119, the entire content of which is hereby incorporated by reference.

### BACKGROUND OF THE INVENTION

1. Field of Invention

The invention relates to the technology associated with a kind of home applications, and more particularly to a method of power management and a system of power management using the same.

2. Related Art

In Daily lives, people continuously consume the various kinds of energy resources. But with the global resources shortage and the seriously problems of global warming, the main theme of international concerns is turning to focus on how to efficiently utilize the limited energy and resources and how to actively retard the global warming effects as well.

FIG. 1 is a conventional sketch map of an embodiment of domestic equipment of power management. As FIG. 1 shows, an electrical appliance 101, a mechanical auto turning on/off equipment 102 and an outlet 103. In the conventional home applications, there is only a mechanical auto turning on/off equipment 102 between the electrical appliance 101 and the outlet 103 for scheming out the power for domestic usage. Therefore, the user can not obtain the power consumption of the electrical appliance 101. To lower the power consumption of the electrical appliance 101, the user can operate the mechanical auto turning on/off equipment 102 only by experience or familiar with the electrical appliance.

Besides, another technique of prior arts is to set a power meter equipment between the electrical appliance and the outlet. Hence, user can monitor the power meter equipment to obtain the power consumption of the electrical appliance. However, there is no well designed scheme of power management among the prior arts. Moreover, the power bill is increasing with the shortage of global resource. Thus, a systematic scheme of power management is an important issue.

### SUMMARY OF THE INVENTION

An object of the invention is to provide a power management system for the tradeoff between the quality of life and the energy saving. In other words, the invention can save energy without affecting the quality of life.

Another object of the invention is to provide a method of power management. The method can scheme out power for domestic usage in a planned way, lower down the waste of electricity and improve the quality of life.

To achieve the above-identified or other objects, the invention provides a power management system comprising a power consumption detector and a controller, wherein the power consumption detector is set between an outlet and an electrical appliance, for examining power consumption of the electrical appliance. The controller is coupled to the power consumption detector and the electrical appliance to obtain the power consumption of the electrical appliance and to estimate a power consumption allowance of a predetermined period according to the power consumption of the electrical appliance.

When a user inputs a target allowance into the controller and the target allowance is different from the power consumption allowance of a predetermined period, the controller schemes out an operation rule and a period of operation time according to characteristics of the electrical appliance, the power consumption allowance of the predetermined period and the target allowance.

The present invention provides another power management system comprising a plurality of power consumption detectors and a controller, wherein the power consumption detectors are respectively set between a plurality of outlets and a plurality of electrical appliances. The power consumption detectors are used for examining power consumption of the electrical appliances. The controller is coupled to the power consumption detectors and the electrical appliances to obtain the power consumption of the electrical appliances and to estimate a power consumption allowance of a predetermined period according to the power consumption of the electrical appliances.

When a user inputs a target allowance which is different to the power consumption allowance of the predetermined period into the controller, the controller schemes out an operation rule and a period of operation time according to characteristics of the electrical appliances, the power consumption allowance of the predetermined period and the target allowance.

The present invention also provide a method of power management, the method includes the steps of: detecting power consumption of one or more electrical appliances; recording power consumption of the electrical appliances; estimating a power consumption allowance of a predetermined period according to the power consumption of the electrical appliances; and scheming out an operation rule and a period of operation time according to characteristics of the electrical appliances, the power consumption allowance of the predetermined period and a target allowance while the target allowance is different from the power consumption allowance of the predetermined period.

In the system and method of power management according to the preferred embodiment of this invention. If the electrical appliance is an air conditioner and the target allowance is less than the power consumption allowance of the predetermined period, the operation rule is gradually increasing a temperature target default value with the using time of the air conditioner. If the electrical appliance is a washing machine and the target allowance is less than the power consumption allowance of the predetermined period, the operation time of the washing machine is changed to off peak hours for electricity. Moreover, the operation time of the washing machine can be shortened according to the difference between the target power consumption and the power consumption allowance. If the electrical appliance is a dimmable luminaire and the target allowance is less than the power consumption allowance, the operation rule is lowering maximum brightness of the dimmable luminaire. In the same way, if the target allowance is less than the power consumption allowance, the operation time of the dimmable luminaire is changed to a predetermined period. For example, the dimmable luminaire is turned off from midnight to morning. Furthermore, the aforementioned power consumption allowance can be power consumption allowance of a year, power consumption allowance of a month, power consumption allowance of a week or power consumption allowance of a day.

The spirit of the invention is to incorporate electrical appliances with the control equipments to be an integrated control so as to detect the ordinary power consumption of electrical appliances. In addition, the calculation of the controller is used so that the power consumption and the power consumption allowance can be estimated. Moreover, the using method and using time of the electrical appliances can be schemed out according to the estimated results and the target allowance. Thus, the tradeoff can be made between the quality of life and energy saving, that is not only to improve the quality of life but also to avoid the waste of energy.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a conventional sketch map of an embodiment of domestic equipment of power management.

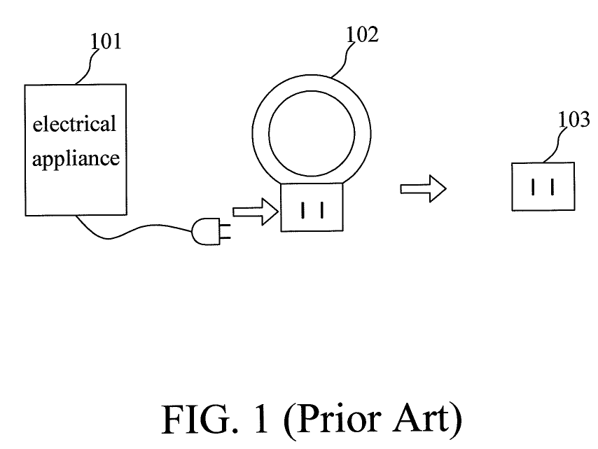

FIG. 2 is a system block diagram of a power management system according to the embodiment of the invention.

FIG. 3 is a flow chart showing a method of power management according to the embodiment of the invention.

### DETAILED DESCRIPTION OF THE INVENTION

The present invention will be apparent from the following detailed description, which proceeds with reference to the accompanying drawings, wherein the same references relate to the same elements.

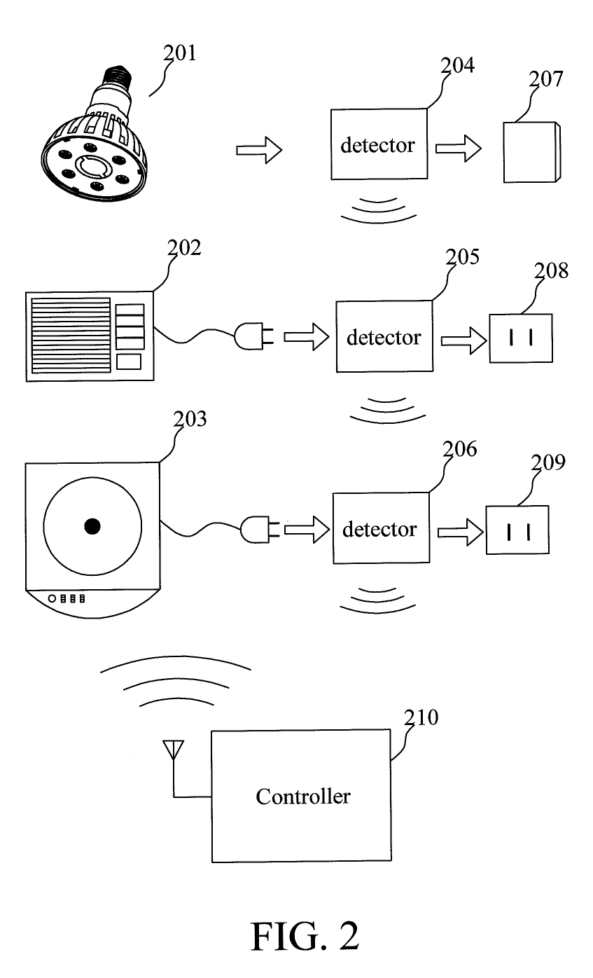

FIG. 2 is a system block diagram of a power management system according to the embodiment of the invention. Referring to FIG. 2, the power management system includes a dimmable luminaire 201, an air conditioner 202, a washing machine 203, a first power consumption detector 204, a second power consumption detector 205, a third power consumption detector 206, a first outlet 207 for luminaire, a second outlet 208, a third outlet 209 and a controller 210. The first power consumption detector 204 is set between the dimmable luminaire 201 and the first outlet 207. The second power consumption detector 205 is set between the air conditioner 202 and the second outlet 208. The third power consumption detector 206 is set between the washing machine 203 and the third outlet 209. The controller 210 can be a portable notebook computer, a PDA, and so forth.

In this embodiment, each electrical appliance (the dimmable luminaire 201, the air conditioner 202, and the washing machine 203) and their corresponding power consumption detector (the first power consumption detector 204, the second power consumption detector 205, and the third power consumption detector 206) can be remotely controlled using the ZIGBEE or the Bluetooth techniques by the controller 210. The ZIGBEE and the Bluetooth techniques are the prior arts and those techniques are not the key points of the present invention, thus detailed description is omitted. At the beginning of using the system, the electrical appliance would be general used for a period, for example, a half day or a day. During the period, the first power consumption detector 204, the second power consumption detector 205, and the third power consumption detector 206 would transfer their corresponding power consumption data of the dimmable luminaire 201, the air conditioner 202, and the washing machine 203 to the controller 210. Then the controller 210 would perform an operation according to the relationship between the power consumption and time of each electrical appliance (the dimmable luminaire 201, the air conditioner 202, and the washing machine 203) to estimate the power consumption of a day, the power consumption of a week, the power consumption of a month, the power consumption of two months, the power consumption of a season and the power consumption of a year.

Afterword, the user can input a target power consumption allowance from the controller 210. The input type of the target power consumption allowance is not limited to the readings on a meter. If the data of charging methods of electricity bill is built in the controller 210, the user can directly input the target allowance of a month or the target allowance of two month, and the controller 210 could transfer the target allowance into the target power consumption or the target power consumption of a moth or the target power consumption of two months. For example, if the target allowance is 4000 dollars/two months and the data of charging method of electricity bill is 3.376 dollars/kilowatt-hour, the maximum power allowance would be 592.26 kilowatt-hour/month. Also, user can use other allowance calculation methods such as the peak/off-peak time charging method and so forth. A person having ordinary skill in the art should know those allowance calculation methods are able to be built in the controller 210, thus detail description is omitted.

Two conditions would happen after inputting the data of target allowance:

First, the target allowance is larger then the power consumption allowance of a month. The user can decide to use the target allowance or not at this time. If not, the user can use the estimated power consumption of a month according to their habit to execute the monthly electricity scheme. If the user uses the target allowance, the controller 210 would automatically provide few proposals for user, for example:
(1) Control the dimmable luminaire 210 in a brighter way;
(2) Increase the using time of the air conditioner 202;
(3) Control the washing machine 203 to perform clothes-drying function after washing;
(4) The mix of above-mentioned (1)˜(3).
   Second, the target allowance is less then the power consumption allowance of a month. The controller 210 would automatically provide few proposals for user, for example:
(A) During sleep time, the air conditioner 202 would open one hour and then rest two hours.
(B) The temperature setting of the air conditioner 202 is set to 23° C. and increases 1° C. per half hour.
(C) Limit the turn on temperature of the air conditioner 202.
(D) Limit the lowest temperature setting value of the air conditioner 202.
(E) Limit the turn-on time of the air conditioner 202.
(F) Limit maximum brightness of the dimmable luminaire 201.
(G) Force the dimmable luminaire 201 to close between 0:00 to 16:00.
(H) Control the washing machine 203 to wash clothes in the off peak time, for example 23:30˜7:00, to save power bill if the electricity charging method is the peak/off-peak time charging method.
(I) Cancel the clothes-drying function or other unnecessary functions to shorten the operation time of the washing machine 203.
(J) Shorten the operation time of the washing machine according to the difference between the target power consumption and the power consumption allowance.
(K) The mix of above-mentioned (A)˜(J).

The above-mentioned schemes can be implemented by using the build-in software of the controller 210, and the detailed description is omitted.

Though three electrical appliances are used for examples in the above embodiments, a person having ordinary skill in the art should know that the system can be operated with more electrical appliances or only an electrical appliance. Thus the present invention should not be limited by the above mentioned three electrical appliances.

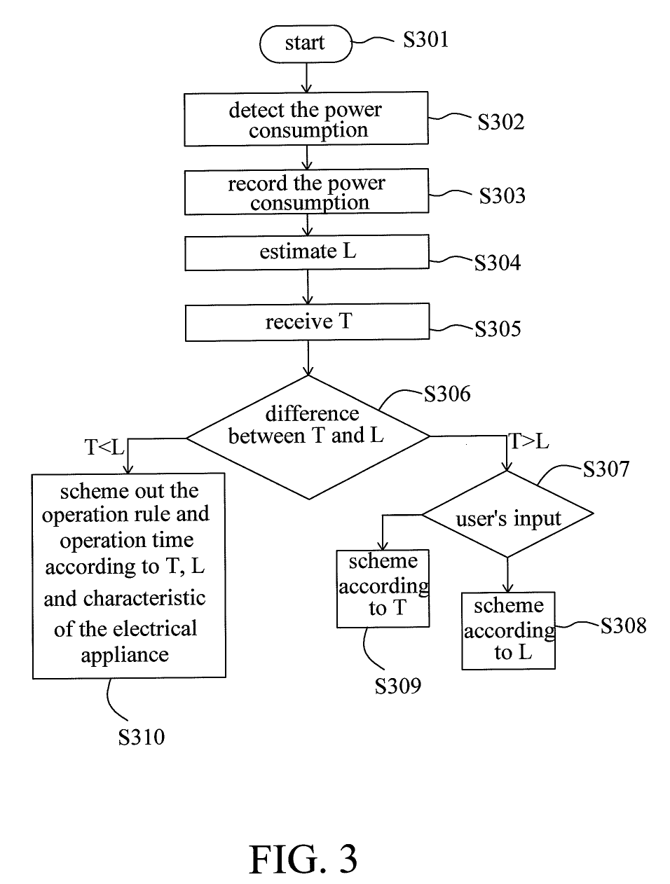

In accordance with the embodiment above, the present invention can be generalized into a method of power management and a flow chart is shown in FIG. 3. Referring to FIG. 3, the method for power management includes the following steps.

In step S301, the method starts.

In step S302, the power consumption of the electrical appliances is detected. As the abovementioned embodiment, the power consumption of one or more electrical appliances is detected by the power consumption detectors 204, 205, 206.

In step S303, the power consumption of the above mentioned electrical appliances is recorded within a short predetermined period.

In step S304, the power consumption allowance of a predetermined period (L) is estimated according to the power consumption of the above mentioned electrical appliances. For example, the above steps S303 and S304 are executed by the controller 210.

In step S305, a target allowance (T) is received. This target allowance can be inputted by user and the type of T is not limited to the amount of money, it can be Watts, kilowatt hour, and so forth.

In step S306, whether or not there is a difference between T and L is judged. If T is larger than L, perform the step S307. If T is less than L, perform the step S310.

In step S307, if T is larger than L, determine to perform the step S308 or step S309 according to user input.

In step S308, the electricity scheme is performed according to the estimated power consumption allowance L (it means that the user elects his/her ordinary habits to execute the electricity scheme).

In step S309, the electricity scheme is performed according to the target allowance T. For example, the above mentioned (1) ˜(4).

In step S310, the operation rule and a period of operation time of the electrical appliances are schemed out according to characteristics of the electrical appliances, the power consumption allowance of the predetermined period and the target allowance to reduce the power consumption. For example, the above mentioned (A) ˜(K).

In summary, the spirit of the present invention is to incorporate electrical appliances with the control equipments to be an integrated control so as to detect the ordinary power consumption of electrical appliances. In addition, the calculation of the controller is used so that the power consumption and the power consumption allowance can be estimated. Moreover, the using method and using time of the electrical appliances can be schemed out according to the estimated results and the target allowance. Thus, the tradeoff can be made between the quality of life and energy saving whether the target allowance is larger than estimated monthly power consumption allowance or not.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A power management system, comprising:
a power consumption detector, set between an outlet and an electrical appliance, for examining power consumption of the electrical appliance; and
a controller, coupled to the power consumption detector and the electrical appliance, for obtaining the power consumption of the electrical appliance and for estimating a power consumption allowance of a predetermined period according to the power consumption of the electrical appliance,
wherein, when a user inputs a target allowance into the controller and the target allowance is different from the power consumption allowance of a predetermined period, the controller schemes out an operation rule and a period of operation time according to characteristics of the electrical appliance, the power consumption allowance of the predetermined period and the target allowance.

2. The power management system according to claim 1, wherein the electrical appliance is an air conditioner; when the target allowance is less than the power consumption allowance of the predetermined period, the operation rule is:
gradually increasing a temperature target default value with the using time of the air conditioner.

3. The power management system according to claim 1, wherein the electrical appliance is an air conditioner; when the target allowance is less than the power consumption allowance of the predetermined period, the operation rule is:
limiting the lowest temperature setting value of the air conditioner.

4. The power management system according to claim 1, wherein the electrical appliance is an air conditioner; when the target allowance is less than the power consumption allowance of the predetermined period, the operation rule is:
limiting the turn-on temperature of the air conditioner.

5. The power management system according to claim 1, wherein the electrical appliance is an air conditioner, when the target allowance is less than the power consumption allowance of the predetermined period, the operation rule is:
limiting the turn-on time of the air conditioner.

6. The power management system according to claim 1, wherein the electrical appliance is a washing machine; when the target allowance is less than the power consumption allowance of the predetermined period, the period of operation time is set to an off peak hours for electricity.

7. The power management system according to claim 6, when the target allowance is less than the power consumption allowance, wherein, the scheme of the period of operation time comprises:
shortening the period of operation time of the washing machine according to the difference between the target power consumption and the power consumption allowance.

8. The power management system according to claim 1, wherein the electrical appliance is a dimmable luminaire, when the target allowance is less than the power consumption allowance, wherein, the operation rule is:
lowering maximum brightness of the dimmable luminaire.

9. The power management system according to claim 1, wherein the electrical appliance is a luminaire, when the target allowance is less than the power consumption allowance, wherein, the operation rule is:
closing the dimmable luminaire in a predetermined period.

10. The power management system according to claim 1, wherein the predetermined period comprises a year, a season, two months, a month, a week and a day.

11. A power management system, comprising:
plural power consumption detectors, respectively set between plural outlets and plural electrical appliances, for examining power consumption of the electrical appliances; and
a controller, coupled to the power consumption detectors and the electrical appliances for obtaining the power consumption of the electrical appliances and for estimating a power consumption allowance of a predetermined period according to the power consumption of the electrical appliances,
wherein, when a user inputs a target allowance into the controller and the target allowance is different from the power consumption allowance of the predetermined period, the controller schemes out an operation rule and a period of operation time according to characteristics of the electrical appliances, the power consumption allowance of the predetermined period and the target allowance.

12. The power management system according to claim 11, wherein the electrical appliances comprise an air conditioner; when the target allowance is less than the power consumption allowance of the predetermined period, the operation rule is:
gradually increasing a temperature target default value with the using time of the air conditioner.

13. The power management system according to claim 11, wherein the electrical appliances comprise an air conditioner; when the target allowance is less than the power consumption allowance of the predetermined period, the operation rule is:
limiting the lowest temperature setting value of the air conditioner.

14. The power management system according to claim 11, wherein the electrical appliances comprise an air conditioner; when the target allowance is less than the power consumption allowance of the predetermined period, the operation rule is:
limiting the turn-on temperature of the air conditioner.

15. The power management system according to claim 11, wherein the electrical appliances comprise an air conditioner; when the target allowance is less than the power consumption allowance of the predetermined period, the operation rule is:
limiting the turn-on time of the air conditioner.

16. The power management system according to claim 11, wherein the electrical appliances comprise a washing machine; when the target allowance is less than the power consumption allowance, the operation time is off peak hours for electricity.

17. The power management system according to claim 16, wherein, the operation time scheme of the washing machine comprises:
shortening the operation time of the washing machine according to the difference between the target power consumption and the power consumption allowance.

18. The power management system according to claim 11, wherein the electrical appliances comprise a dimmable luminaire, when the target allowance is less than the power consumption allowance, wherein, the operation rule is:
lowering maximum brightness of the dimmable luminaire.

19. The power management system according to claim 11, wherein the electrical appliances comprise a luminaire, when the target allowance is less than the power consumption allowance, wherein, the operation rule is:
closing the dimmable luminaire in a predetermined period.

20. The power management system according to claim 11, wherein the predetermined period comprises a year, a season, two months, a month, a week and a day.

21. A power management method, comprising:
detecting power consumption of one or more electrical appliances;
recording power consumption of the electrical appliances;
estimating a power consumption allowance of a predetermined period according to the power consumption of the electrical appliances;
scheming out an operation rule and a period of operation time according to characteristics of the electrical appliances, the power consumption allowance of the predetermined period and the target allowance while a target allowance which is different to the power consumption allowance of the predetermined period.

22. The power management method according to claim 21, wherein the electrical appliances comprise an air conditioner; when the target allowance is less than the power consumption allowance of the predetermined period, the operation rule is:
gradually increasing a temperature target default value with the using time of the air conditioner.

23. The power management method according to claim 21, wherein the electrical appliances comprise an air conditioner; when the target allowance is less than the power consumption allowance of the predetermined period, the operation rule is:
limiting the lowest temperature setting value of the air conditioner.

24. The power management method according to claim 21, wherein the electrical appliances comprise an air conditioner; when the target allowance is less than the power consumption allowance of the predetermined period, the operation rule is:
limiting the turn-on temperature of the air conditioner.

25. The power management method according to claim 21, wherein the electrical appliances comprise an air conditioner; when the target allowance is less than the power consumption allowance of the predetermined period, the operation rule is:
limiting the turn-on time of the air conditioner.

26. The power management method according to claim 21, wherein the electrical appliances comprise a washing machine; when the target allowance is less than the power consumption allowance, the operation time is off peak hours for electricity.

27. The power management method according to claim 26, wherein, the operation time scheme of the washing machine comprises:
shortening the operation time of the washing machine according to the difference between the target allowance and the power consumption allowance.

28. The power management method according to claim 21, wherein the electrical appliances comprise a dimmable luminaire, when the target allowance is less than the power consumption allowance, wherein, the operation rule is:
lowering maximum brightness of the dimmable luminaire.

29. The power management method according to claim 21, wherein the electrical appliances comprise a luminaire, when the target allowance is less than the power consumption allowance, wherein, the operation rule is:
closing the dimmable luminaire in a predetermined period.

30. The power management method according to claim 21, wherein the predetermined period comprises a year, a season, two months, a month, a week and a day.

31. A power management system, comprising:
a power consumption detector, set in an electrical appliance, for examining power consumption of the electrical appliance; and
a controller for connecting the power consumption detector and the electrical appliance to obtain the power consumption of the electrical appliance and estimate a power consumption allowance of a predetermined period according to the power consumption of the electrical appliance,
wherein, when a user inputs a target allowance into the controller and the target allowance is different from the power consumption allowance of a predetermined period, the controller schemes out an operation rule and a period of operation time according to characteristics of the electrical appliance, the power consumption allowance of the predetermined period and the target allowance.

32. The power management system according to claim 31, wherein the electrical appliance is an air conditioner; when the target allowance is less than the power consumption allowance of the predetermined period, the operation rule is:
gradually increasing a temperature target default value with the using time of the air conditioner.

33. The power management system according to claim 31, wherein the electrical appliance is an air conditioner; when the target allowance is less than the power consumption allowance of the predetermined period, the operation rule is:
limiting the lowest temperature setting value of the air conditioner.

34. The power management system according to claim 31, wherein the electrical appliance is an air conditioner; when the target allowance is less than the power consumption allowance of the predetermined period, the operation rule is:
limiting the turn-on temperature of the air conditioner.

35. The power management system according to claim 31, wherein the electrical appliance is an air conditioner, when the target allowance is less than the power consumption allowance of the predetermined period, the operation rule is:
limiting the turn-on time of the air conditioner.

36. The power management system according to claim 31, wherein the electrical appliance is a washing machine; when the target allowance is less than the power consumption allowance of the predetermined period, the operation time is off peak hours for electricity.

37. The power management system according to claim 36, when the target power consumption is less than the power consumption allowance, wherein, the operation time scheme comprises:
shortening the operation time of the washing machine according to the difference between the target target allowance and the power consumption allowance.

38. The power management system according to claim 31, wherein the electrical appliance is a dimmable luminaire, when the target target allowance is less than the power consumption allowance, wherein, the operation rule is:
lowering maximum brightness of the dimmable luminaire.

39. The power management system according to claim 31, wherein the electrical appliance is a luminaire, when the target target allowance is less than the power consumption allowance, wherein, the operation rule is:
closing the dimmable luminaire in a predetermined period.

40. The power management system according to claim 31, wherein the predetermined period comprises a year, a season, two months, a month, a week and a day.
